(19) United States
(12) Patent Application Publication
(10) Pub. No.: US 2026/0241948 A1
(43) Pub. Date: Aug. 20, 2026

(54) DRIVING ASSISTANCE SYSTEM, STORAGE DEVICE STORING DRIVING ASSISTANCE PROGRAM, DRIVING ASSISTANCE METHOD

(71) Applicant: J-QuAD DYNAMICS Inc., Tokyo (JP)

(72) Inventor: HAJIME KUMABE, Tokyo (JP)

(21) Appl. No.: 19/056,899

(22) Filed: Feb. 19, 2025

(51) Int. Cl. B60W 50/14; B60W 30/06; B60W 50/00; G06T 11/00; G06V 20/58

(52) U.S. Cl. CPC B60W 50/14; B60W 30/06; B60W 50/0097; G06T 11/00; G06V 20/58; B60W 2050/146

(57) ABSTRACT

A driving assistance system assisting the driving of a host vehicle, the driving assistance system includes a processor configured to execute identifying a different road user present in external environment of the host vehicle; and generating virtual video data that virtually represents the host vehicle as viewed from a perspective of the different road user so as to be reflected in a driving behavior of the host vehicle.

### TECHNICAL FIELD

The present disclosure relates to driving assistance technology that supports the operation of a host vehicle.

### BACKGROUND

A related art describes determining the driving behavior of the host vehicle based on the collision risk with other road users present in the external environment of the host vehicle.

### SUMMARY

A driving assistance system assisting the driving of a host vehicle, the driving assistance system includes a processor configured to execute identifying a different road user present in external environment of the host vehicle; and generating virtual video data that virtually represents the host vehicle as viewed from a perspective of the different road user so as to be reflected in a driving behavior of the host vehicle.

### BRIEF DESCRIPTION OF THE DRAWINGS

Objects, features and advantages of the present disclosure will become more apparent from the following detailed description made with reference to the accompanying drawings. In the drawings:

FIG. 1 is a block diagram showing a physical configuration of a driving assistance system according to the first embodiment;

FIG. 2 is a schematic diagram showing a driving environment of a host vehicle to which the first embodiment is applied;

FIG. 3 is a block diagram showing a functional configuration of the driving assistance system according to the first embodiment;

FIG. 4 is a schematic diagram showing a display state of virtual video data according to the first embodiment;

FIG. 5 is a characteristic table showing display conditions for displaying the virtual video data according to the first embodiment;

FIG. 6 is a schematic diagram for explaining an arbitration of a driving control pattern according to the first embodiment;

FIG. 7 is a schematic diagram for explaining an arbitration of a driving control pattern according to the first embodiment;

FIG. 8 is a schematic diagram for explaining an arbitration of a driving control pattern according to the first embodiment;

FIG. 9 is a schematic diagram for explaining an arbitration of a driving control pattern according to the first embodiment;

FIG. 10 is a schematic diagram for explaining an arbitration of a driving control pattern according to the first embodiment;

FIG. 11 is a schematic diagram for explaining an arbitration of a driving control pattern according to the first embodiment;

FIG. 12 is a schematic diagram for explaining an arbitration of a driving control pattern according to the first embodiment;

FIG. 13 is a flowchart showing the driving assistance processing according to the first embodiment;

FIG. 14 is a block diagram showing the functional configuration of a driving assistance system according to the second embodiment;

FIG. 15 is a schematic diagram for explaining the arbitration of a driving control pattern and driving control parameters according to the second embodiment;

FIG. 16 is a schematic diagram for explaining the arbitration of a driving control pattern and driving control parameters according to the second embodiment;

FIG. 17 is a schematic diagram for explaining the arbitration of a driving control pattern and driving control parameters according to the second embodiment;

FIG. 18 is a schematic diagram for explaining the arbitration of a driving control pattern and driving control parameters according to the second embodiment;

FIG. 19 is a schematic diagram for explaining the arbitration of a driving control pattern and driving control parameters according to the second embodiment; and

FIG. 20 is a schematic diagram for explaining the arbitration of a driving control pattern and driving control parameters according to the second embodiment.

### DETAILED DESCRIPTION

In a related art, although collision risk is assessed using a mathematical model between a host vehicle and a different road user, the mathematical model is constructed based on the predicted movement trajectories of the different road user from the perspective of the host vehicle. Consequently, the driving behavior of the host vehicle does not necessarily ensure safe and secure driving behavior from the perspective of the different road user, raising a concern that the mathematical model may lead to unforeseen interactions between the host vehicle and the different road user.

The present disclosure provides a driving assistance system that ensures safety and security in interactions between the host vehicle and the different road user. The present disclosure provides a driving assistance program that ensures safety and security in interactions between the host vehicle and the different road user. The present disclosure provides a driving assistance method that ensures safety and security in interactions between the host vehicle and the different road user.

According to one aspect of the present disclosure, a driving assistance system assisting the driving of a host vehicle is provided. The driving assistance system includes a processor configured to execute identifying a different road user present in external environment of the host vehicle; and generating virtual video data that virtually represents the host vehicle as viewed from a perspective of the different road user so as to be reflected in a driving behavior of the host vehicle.

According to one aspect of the present disclosure, a driving assistance program stored in a storage medium for assisting driving of a host vehicle is provided. The driving assistance program includes instructions to be executed by a processor, the instructions including identifying a different road user present in external environment of the host vehicle; and generating virtual video data that virtually represents the host vehicle as viewed from the perspective of the different road user so as to be reflected in driving behavior of the host vehicle.

According to one aspect of the present disclosure, a driving assistance method executed by a processor for assisting driving of a host vehicle is provided. The method includes identifying a different road user present in external environment of the host vehicle; and generating virtual video data that virtually represents the host vehicle as viewed from a perspective of the different road user so as to be reflected in driving behavior of the host vehicle.

In the first to third aspects, the different road user present in the external environment of the host vehicle are identified. Therefore, according to the first to third aspects, virtual video data that virtually represents the host vehicle as viewed from the perspective of the different road user is generated in a manner that can be reflected in the driving behavior of the host vehicle. According to the virtual video data thus generated, it is possible to continuously reflect the perspective of the different road user in the driving behavior of the host vehicle, thereby ensuring safety and security in interactions between the host vehicle and the different road user.

Hereinafter, embodiments of the present disclosure will be described with reference to the drawings. In each embodiment, corresponding components may be denoted by the same reference numerals, and redundant explanations may be omitted. Additionally, when only a part of a configuration is described in each embodiment, the configuration of other parts may be applied from other embodiments described earlier. Furthermore, the combinations of configurations explicitly stated in the descriptions of each embodiment are not the only possible combinations, and unless there is a particular problem, configurations from multiple embodiments may be partially combined even if not explicitly stated.

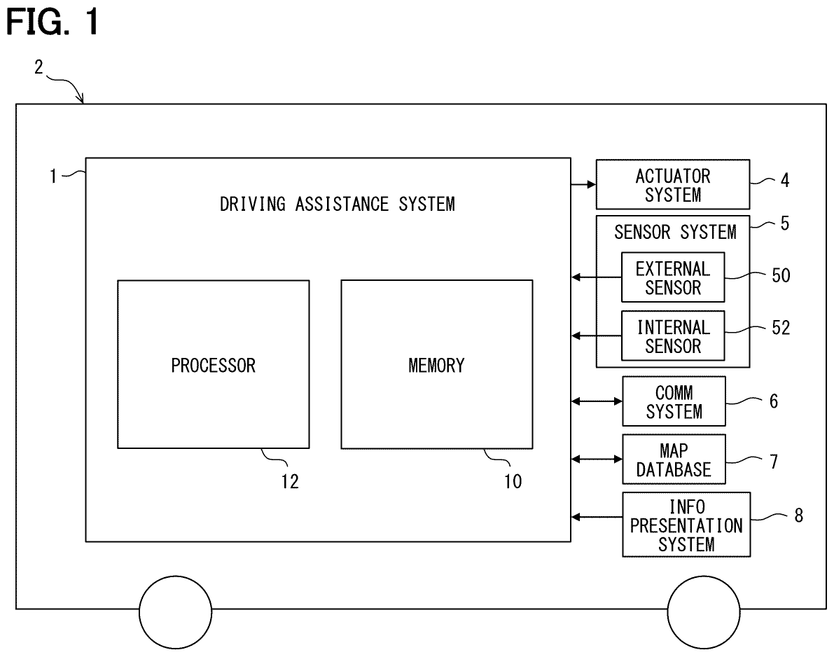

The driving assistance system 1 according to the first embodiment shown in FIG. 1 supports the driving of a host vehicle 2. At least a part of the driving assistance system 1 is mounted on the host vehicle 2. The host vehicle 2 to which the driving assistance system 1 is applied may be capable of realizing a level of autonomous driving, as defined by standards such as SAE J3016, where manual driving support tasks exist alongside autonomous driving tasks. Such a host vehicle 2 may be a road user such as an automobile or a truck, and may also be referred to as an ego-vehicle, a subject vehicle. Accordingly, as an operator of the host vehicle 2, the driving assistance system 1 targets a driver who is capable of performing manual driving operations while being on board the host vehicle 2 for driving assistance.

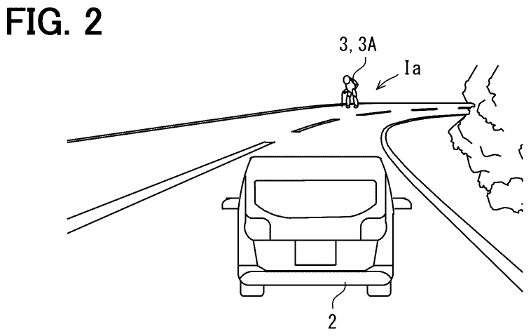

As shown in FIG. 2, the driving environment in which the host vehicle 2 travels assumes traffic scenes where a different road user (also referred to as other road user, another road user) 3, other than the host vehicle 2, are present. A different road user 3 includes both a non-vulnerable user and a vulnerable road user, depending on their vulnerability. Non-vulnerable road users include at least one type of moving body in which humans ride, such as automobiles, trucks, motorcycles, and bicycles. Vulnerable users include, for example, pedestrians. The different road user 3 may be in either a stationary state or a moving state in the assumed traffic scenes.

As shown in FIG. 1, the host vehicle 2 is equipped with an actuator system 4, a sensor system 5, a communication system 6, a map database (DB) 7, and an information presentation system 8, along with at least a part of the driving assistance system 1. However, FIG. 1 representatively shows an example where the entire driving assistance system 1, implemented in the form of processing circuits (e.g., processing ECUs) or semiconductor devices (e.g., semiconductor chips), is mounted on the host vehicle 2.

The actuator system 4 is configured to control the driving behavior of the host vehicle 2 based on control commands provided by the driving assistance system 1. The actuator system 4 may include at least one type of powertrain actuator, such as an internal combustion engine or a motor generator. The actuator system 4 may also include at least one type of braking actuator, such as a brake unit. Additionally, the actuator system 4 may include at least one type of steering actuator, such as a power steering unit.

The sensor system 5 acquires sensing information that can be utilized by the driving assistance system 1 by sensing the external and internal environments of the host vehicle 2. For this purpose, the sensor system 5 includes an external sensor 50 and an internal sensor 52.

The external sensors 50 sense an object present in the external environment of the host vehicle 2, including a different road user 3. The external sensor 50 for object sensing may include at least one type of sensor, such as an image sensor (i.e., an onboard camera), LiDAR (light detection and ranging/laser imaging detection and ranging), a laser sensor, a millimeter-wave sensor, or a sonar sensor. The external sensors 50 for object sensing are preferably implemented in combination to sense the front, sides, and rear of the host vehicle 2.

The internal sensor 52 senses specific physical quantity related to vehicle motion within the internal environment of the host vehicle 2. The internal sensor 52 for motion sensing may include at least one type of sensor, such as a speed sensor, an acceleration sensor, or a gyro sensor. The internal sensor 52 may also sense the operation or state of occupants, including the driver, within the internal environment of the host vehicle 2. The internal sensor 52 for occupant sensing may include at least one type of sensor, such as a steering angle sensor, a steering torque sensor, a brake pedal sensor, an accelerator pedal sensor, a shift sensor, an occupant camera, a steering switch, a biometric sensor, a seating sensor, or an in-vehicle equipment switch.

The communication system 6 acquires communication information that can be utilized by the driving assistance system 1 through wireless communication. The communication system 6 may receive positioning signals from GNSS (global navigation satellite system) satellites present in the external environment of the host vehicle 2. The communication system 6 for positioning may include, for example, a GNSS receiver. The communication system 6 may also send and receive communication signals to and from a V2X system present in the external environment of the host vehicle 2. The communication system 6 for V2X communication may include at least one type of device, such as a DSRC (dedicated short range communications) transceiver or a cellular V2X (C-V2X) transceiver. The communication system 6 may also send and receive communication signals to and from a mobile terminal present in the internal environment of the host vehicle 2. The communication system 6 for terminal communication may include at least one type of device, such as a Bluetooth (registered trademark) device, a Wi-Fi (registered trademark) device, or an infrared communication device.

The map DB 7 stores map information that can be utilized by the driving assistance system 1. The map DB 7 is configured to include at least one type of non-transitory tangible storage medium, such as a semiconductor memory, a magnetic medium, or an optical medium. The map DB 7 may serve as a DB for a locator that estimates the self-position of the host vehicle 2. The map DB 7 may also serve as a DB for a navigation unit that navigates the driving route of the host vehicle 2. The map DB 7 may be constructed by combining multiple types of DBs.

The map DB 7 acquires and stores the latest map information through V2X communication with an external center via the communication system 6, for example. The map information is digitized in two dimensions or three dimensions to represent the external environment in which the host vehicle 2 travels. High-precision digital map data may be employed as the three-dimensional map information.

The map information includes road information representing at least one of the position, shape, and road surface condition of road structures. The road information included in the map information may contain still images of roads. The road information included in the map information may also contain multiple computer graphics (CG) images depicting roads in two dimensions or three dimensions from multiple viewpoints. The map information may include structure information representing at least one of the position and shape of buildings and traffic signals facing the road. The map information may include sign information representing at least one of the position and shape of signs and lane markings attached to the road.

The information presentation system 8 presents notification information to the occupants, including the driver, of the host vehicle 2. The information presentation system 8 presents notification information by stimulating the visual senses of the occupants in the host vehicle 2. The visual information presentation type of the information presentation system 8 may include at least one type of device, such as an onboard monitor, a head-up display (HUD), a combination meter, a navigation unit, or an illumination unit.

The information presentation system 8 may present notification information by stimulating the auditory senses of the occupants. The auditory information presentation type of the information presentation system 8 may include at least one type of device, such as a speaker, a buzzer, or a vibration unit. The information presentation system 8 may present notification information by stimulating the tactile senses of the occupants. The tactile information presentation type of the information presentation system 8 may include at least one type of device, such as a vibration unit, a reaction force unit, or an air conditioning unit.

The driving assistance system 1 is connected to the actuator system 4, the sensor system 5, the communication system 6, the map DB 7, and the information presentation system 8 via at least one type of connection, such as a local area network (LAN), a wire harness, an internal bus, or a wireless communication line. The driving assistance system 1 is configured to include at least one dedicated computer.

The dedicated computer constituting the driving assistance system 1 may be an integrated ECU (electronic control unit) that integrates the driving control of the host vehicle 2. The dedicated computer constituting the driving assistance system 1 may be a sensing ECU that processes sensing information in the driving control of the host vehicle 2. The dedicated computer constituting the driving assistance system 1 may be a recognition ECU that recognizes the external environment in the driving control of the host vehicle 2. The dedicated computer constituting the driving assistance system 1 may be a locator ECU that estimates the self-position of the host vehicle 2.

The dedicated computer constituting the driving assistance system 1 may be a planning ECU that plans the driving control of the host vehicle 2. The dedicated computer constituting the driving assistance system 1 may be a navigation ECU that navigates the driving route in the driving control of the host vehicle 2. The dedicated computer constituting the driving assistance system 1 may be an actuator ECU that controls the actuator system 4 as part of the driving control of the host vehicle 2.

The dedicated computer constituting the driving assistance system 1 may be an information management ECU that controls the information presentation system 8 as part of the driving control of the host vehicle 2. The dedicated computer constituting the driving assistance system 1 may also be at least one external computer that constructs an external center or a mobile terminal capable of communication via the communication system 6.

The dedicated computer constituting the driving assistance system 1 includes at least one memory 10 and at least one processor 12. The memory 10 is a non-transitory tangible storage medium that non-temporarily stores programs and data readable by the computer, such as a semiconductor memory, a magnetic medium, or an optical medium. The processor 12 includes at least one type of core, such as a CPU (central processing unit), a GPU (graphics processing unit), or a RISC (reduced instruction set computer) CPU.

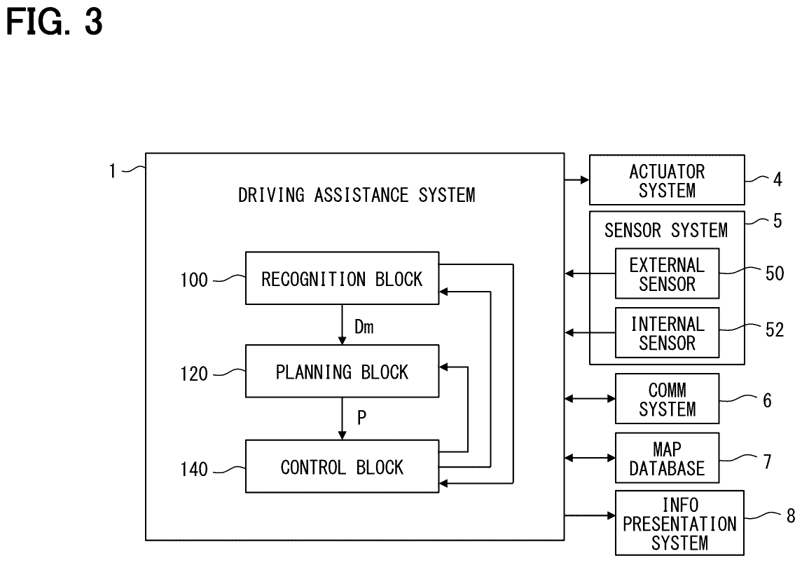

The processor 12 executes multiple instructions included in the driving assistance program stored in the memory 10 as software. As a result, the driving assistance system 1 constructs multiple functional blocks to perform the driving assistance processing of the host vehicle 2. The multiple functional blocks constructed by the driving assistance system 1 include a recognition block 100, a planning block 120, and a control block 140, as shown in FIG. 3.

The recognition block 100 acquires sensing information from the sensor system 5. The recognition block 100 acquires communication information from the communication system 6. The recognition block 100 acquires map information from the map DB 7. The planning block 120 acquires control data of the host vehicle 2 related to past driving behavior from the control block 140. The recognition block 100 processes these acquired pieces of information individually and then fuses them to generate recognition data that recognizes the external and internal environments of the host vehicle 2. Therefore, the recognition data generated by the recognition block 100 represents the state of the external and internal environments recognized for each traffic scene in which the host vehicle 2 travels.

Specifically, the recognition block 100 generates recognition data by recognizing objects, including the different road user 3, obstacles, and structures in the external environment of the host vehicle 2. The recognition data related to the type of object may represent at least one type of physical quantity of motion, such as separation distance, direction of movement, relative speed, and relative acceleration. The recognition data related to the type of object may represent the classification of objects clustered based on such physical quantities of motion.

The recognition block 100 may generate recognition data by recognizing markings associated with the road on which the host vehicle 2 travels. The recognition data related to the type of marking may represent at least one type of marking state, such as signs, lane markings, and traffic signals. The recognition data related to markings may represent traffic rules recognized from such marking states.

The recognition block 100 may generate recognition data by recognizing the roads on which the host vehicle 2 is currently traveling and will travel in the future. The recognition data related to the type of road may represent at least one type of road condition, such as the road surface, lanes, road edges, and free space.

The recognition block 100 may generate recognition data through localization, which recognizes the self-state, including the self-position of the host vehicle 2. The recognition data related to the self-state may further include at least one type of static performance data regarding the external sensor 50 (particularly an image sensor) of the host vehicle 2, such as mounting coordinates, sensing range, sensing resolution, and sensing accuracy. The recognition block 100 may simultaneously generate update information for the map information related to the roads on which the host vehicle 2 travels and feed this update information back to the map DB 7.

The recognition block 100 may generate recognition data by recognizing the manual driving operations of the driver with respect to the host vehicle 2. The recognition data related to manual driving operations may represent at least one type of operation parameter corresponding to the driver's operations, such as steering angle, steering torque, brake pedal operation amount, accelerator pedal operation amount, and shift operation position.

Among the multiple types of recognition data described above, the recognition block 100 identifies a target user 3A from among the different road users 3 shown in FIG. 2, based on at least the recognition data related to objects and the self-state. At this time, the different road user 3 present within an interaction area Ia set within a predetermined distance range in the traveling direction of the host vehicle 2 are identified as the target user 3A. The interaction area Ia refers to an area where interactions between the host vehicle 2 and the different road user 3 are expected due to their relative approach.

The target user 3A is identified as the different road user 3 expected to relatively approach the host vehicle 2 by being present in such an interaction area Ia. Therefore, the relative approach between the host vehicle 2 and the different road user 3 is recognized based on state values of the host vehicle 2 and the different road user 3, such as position coordinates and velocity vectors. At this time, the performance data of the external sensors 50 (particularly the mounting coordinates of the image sensors) representing the state values of the host vehicle 2 in the recognition data related to the self-state may also be used for recognizing the relative approach.

At least one user among the different road users 3 present in the interaction area Ia and in a relative approach relationship with the host vehicle 2 is selected as the target user 3A. The target user 3A may be selected as the different road user 3 present at the closest distance to the host vehicle 2 within the interaction area Ia. However, if multiple different road users 3 are present in the interaction area Ia, the different road user 3 with the highest vulnerability (e.g., a pedestrian) present at the closest distance to the host vehicle 2 may be selected as the target user 3A. Therefore, in the following description, the closest distance is understood to include the concept of considering the vulnerability of the different road user 3 along with the concept of disregarding it.

Multiple different road users 3 present in the interaction area Ia and in a relative approach relationship with the host vehicle 2 may be selected as the target user 3A. However, the target user 3A, which is the display target of the virtual video data Dm in the recognition block 100 described later, is preferably limited to a single different road user 3 present at the closest distance. On the other hand, the target user 3A, which is the interaction prediction target and arbitration target in the planning block 120 described later, may include at least the different road user 3 at the closest distance, and may also include some or all of the different road users 3 at distances other than the closest distance.

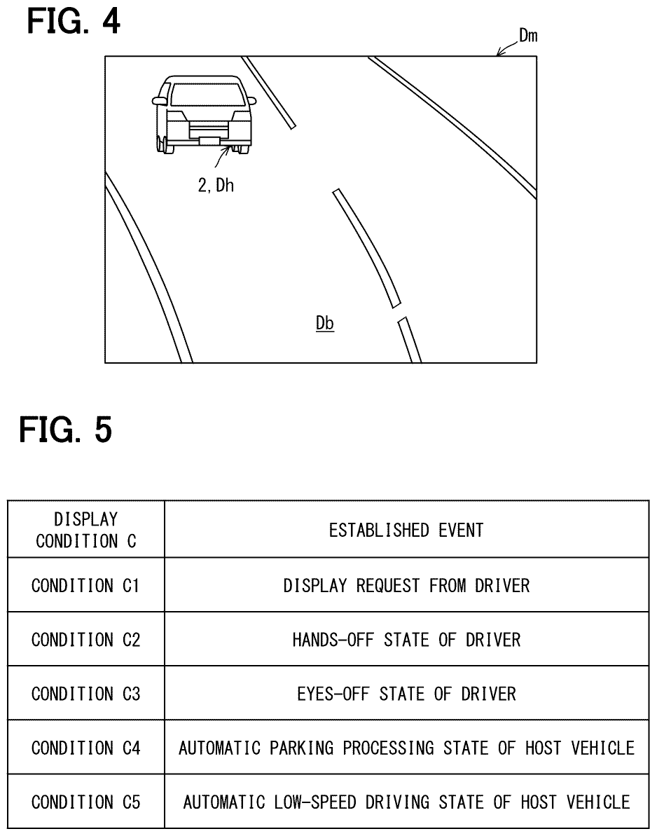

The recognition block 100 shown in FIG. 3 acquires virtual video data Dm, which virtually represents the host vehicle 2 as viewed from the perspective of the identified target user 3A, as a type of recognition data. At this time, the virtual video data Dm is generated in a manner that can be reflected in the driving behavior of the host vehicle 2 by being used for interaction prediction and driving control in the planning block 120 described later. Therefore, as shown in FIG. 4, the virtual video data Dm representing the host vehicle 2 is generated periodically and continuously for each video frame based on the latest recognition data related to at least objects and the self-state.

For the generation of the virtual video data Dm, multiple still images of the host vehicle 2, captured from various viewpoints and stored in the memory 10, may be read out as vehicle image portions Dh representing the host vehicle 2, as shown in FIG. 4. The generation of the virtual video data Dm may also involve reading out multiple CG images of the host vehicle 2, drawn in two dimensions or three dimensions from various viewpoints and stored in the memory 10, as vehicle image portions Dh.

For the generation of the virtual video data Dm, multiple still images of roads, captured from various viewpoints and stored in the map DB 7, may be read out as background image portions Db representing the background of the vehicle image portions Dh, as shown in FIG. 4. The generation of the virtual video data Dm may also involve reading out multiple CG images of roads, drawn in two dimensions or three dimensions from various viewpoints and stored in the map DB 7, as background image portions Db. These background image portions Db may alternatively be stored in the memory 10 instead of the map DB 7 and read out from the memory 10.

In the generation of the virtual video data Dm, periodic processing to generate image data for one frame of the virtual video data Dm by performing viewpoint transformation on the vehicle image portions Dh and the background image portions Db using a viewpoint transformation algorithm, such as a projection transformation or an affine transformation, stored in the memory 10, may be repeated. In each periodic processing, the viewpoint transformation algorithm may be provided with viewpoint coordinates calculated from state values of the host vehicle 2 and the target user 3A, such as position coordinates and velocity vectors, and/or the viewpoint of the target user 3A relative to the host vehicle 2. At this time, the viewpoint transformation algorithm may also be provided with performance data of the external sensors 50 (particularly the mounting coordinates of the image sensor) used to identify the target user 3A, as part of the state values of the host vehicle 2 in the recognition data related to the self-state.

In the generation of the virtual video data Dm, periodic processing to generate image data for one frame of the virtual video data Dm by performing viewpoint transformation on the vehicle image portions Dh and the background image portions Db using a machine learning model, such as neural radiance fields (NeRF), constructed in the memory 10, may be repeated. In each periodic processing, the machine learning model may be provided with viewpoint coordinates calculated from state values of the host vehicle 2 and the target user 3A, such as position coordinates and velocity vectors, and/or the viewpoint of the target user 3A relative to the host vehicle 2. At this time, the machine learning model may also be provided with performance data of the external sensors 50 (particularly the mounting coordinates of the image sensor) used to identify the target user 3A, as part of the state values of the host vehicle 2 in the recognition data related to the self-state.

The recognition block 100 controls the visual information presentation type of the information presentation system 8 to continuously display the generated virtual video data Dm frame by frame to the driver within the host vehicle 2. The display of the virtual video data Dm may be performed continuously while the host vehicle 2 is in operation, but in the driving assistance system 1, it is permitted and/or executed based on conditions related to the driver or events concerning the driver. Here, permission includes not only cases where execution is performed in direct response to the fulfillment of the corresponding condition but also cases where execution is deferred until at least one other condition is fulfilled. In the following description, the conditions under which the display of the virtual video data Dm is permitted and/or executed are referred to as display conditions C.

As shown in FIG. 5, the display condition C for the virtual video data Dm may be condition C1, where the internal sensor 52 of the occupant sensing type receives a display request from the driver of the host vehicle 2. The display condition C may be condition C2, where the driver is in a hands-off state, permitted to release their hands from the steering wheel of the host vehicle 2. The display condition C may be condition C3, where the driver is in an eyes-off state, permitted to release their eyes from the forward field of view of the host vehicle 2, in addition to being in a hands-off state.

The display condition C may be condition C4, where the host vehicle 2 is in an automatic parking process state. The display condition C may be condition C5, where the host vehicle 2 is in an automatic low-speed driving state within a permitted speed range (e.g., 10 km/h or less). The display condition C may also be a composite condition established by the simultaneous fulfillment of multiple conditions among conditions C1, C2, C3, C4, and C5, thereby executing the display of the virtual video data Dm.

The recognition block 100, upon the fulfillment of such display conditions C, may control the auditory information presentation type of the information presentation system 8 to emit, for example, a warning sound or a voice alert to the driver within the host vehicle 2. The recognition block 100, upon the fulfillment of the display conditions C, may also control the tactile information presentation type of the information presentation system 8 to provide, for example, vibrations, reaction forces, or air conditioning wind to the driver within the host vehicle 2.

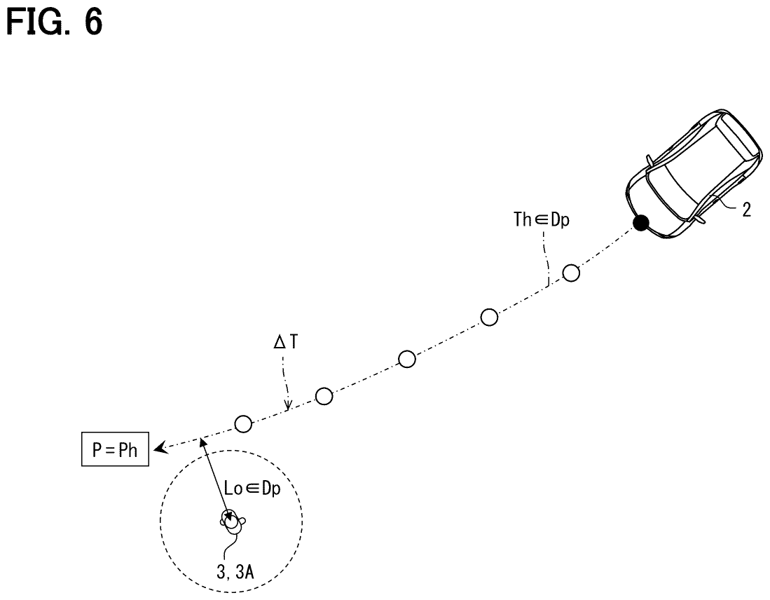

The planning block 120, as shown in FIG. 3, acquires recognition data from the recognition block 100. The planning block 120 acquires control data of the host vehicle 2 related to past driving behavior from the control block 140. Based on these acquired data, the planning block 120 generates prediction data Dp, which predicts the interaction between the host vehicle 2 and the different road user 3, including the target user 3A (see FIG. 6 to FIG. 12 for details).

The generation of the prediction data Dp is performed to control the driving behavior of the host vehicle 2 in the subsequent control block 140 according to the virtual video data Dm. Therefore, the virtual video data Dm included in the recognition data from the recognition block 100 is used for interaction prediction between the host vehicle 2 and the target user 3A by the planning block 120.

In the interaction prediction with the target user 3A, as shown in FIG. 6 to FIG. 12, the future driving trajectory Th of the host vehicle 2 is predicted along with the time transition of the relative relationship with the target user 3A, resulting in the generation of prediction data Dp representing the prediction results. In FIG. 6 to FIG. 12, multiple black and white circles on the driving trajectory Th represent driving control points for each control cycle in the driving assistance system 1, schematically illustrated with some points omitted for simplicity.

The driving trajectory Th predicted during the generation of the prediction data Dp specifies the position coordinates for each control cycle of the trajectory that the host vehicle 2 will follow in the future. The driving trajectory Th may also specify at least one type of physical quantity of motion assumed for each control cycle on the trajectory, such as speed, acceleration, yaw angle, and yaw rate. The prediction of such a driving trajectory Th may utilize at least one type of data, such as the result of the planned future driving route of the host vehicle 2 based on the acquired data by the planning block 120 and recognition data related to the driver's manual driving operations, along with the virtual video data Dm.

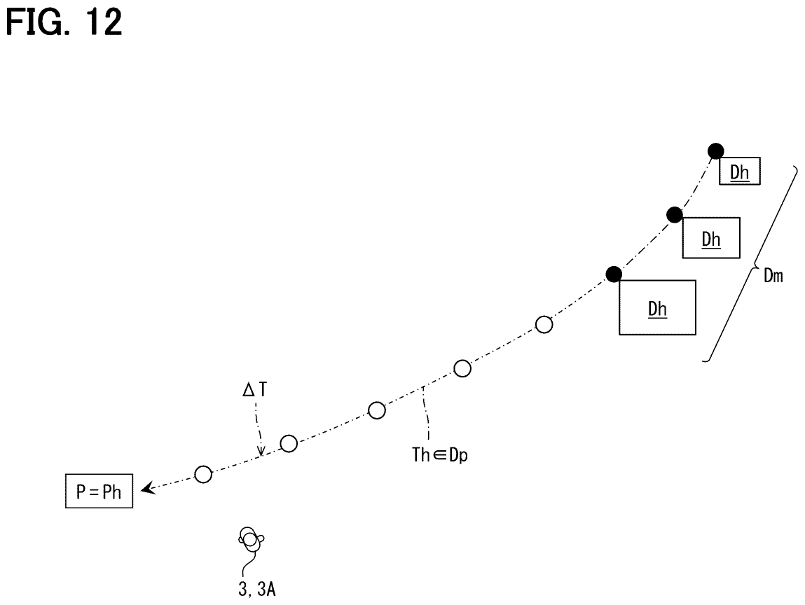

As for the relative relationship between the host vehicle 2 and the target user 3A, the time transition of physical quantities used in the arbitration process in the planning block 120 described later is predicted, and this time transition is preferably included in the prediction data Dp associated with the driving trajectory Th. Such interaction prediction, including the driving trajectory Th and the relative relationship, is performed based on at least one type of information grasped from the virtual video data Dm, such as the time change in the area of the vehicle image portion Dh (see FIG. 12 for details), the behavior of the vehicle image portion Dh (i.e., the behavior of the host vehicle 2), and the posture of the vehicle image portion Dh (i.e., the posture of the host vehicle 2).

The planning block 120 may adjust the level of autonomous driving of the host vehicle 2 based on the acquired data and the prediction data Dp. The adjustment of the autonomous driving level may include the transition of the driving mode between the autonomous driving task and the manual driving assistance task, facilitating the handover of the driving task between the driving assistance system 1 and the driver. Such handover may be realized at least one type of timing, such as the timing of a transfer request from the driver, the timing of entering or exiting the operational design domain (ODD) of autonomous driving, and the timing of the minimum risk maneuver (MRM) necessity.

The planning block 120 executes a control plan to control the driving behavior of the host vehicle 2 based on the aforementioned acquired data and prediction data Dp. At this time, control commands directed to the actuator system 4 are generated in order to control the driving tasks according to the autonomous driving level, among the autonomous driving tasks and manual driving assistance tasks in the host vehicle 2. Examples of driving tasks corresponding to the autonomous driving level include adaptive cruise control (ACC), autonomous emergency braking (AEB), and lane keeping assist (LKA).

The planning block 120 plans control commands to control the driving behavior of the host vehicle 2 in accordance with the interaction predicted based on the virtual video data Dm between the host vehicle 2 and the target user 3A. Therefore, the control commands are generated to adapt the driving control pattern to the prediction data Dp, which includes the driving trajectory Th predicted based on the virtual video data Dm. Specifically, as shown in FIG. 3 and FIG. 6 to FIG. 12, the control commands generated by the planning block 120 in the first embodiment include a driving control pattern P that selectively reflects the self-perspective of the host vehicle 2 and the other perspective of the target user 3A.

Specifically, as the driving control pattern P shown in FIG. 6 to FIG. 12, the planning block 120 arbitrates between a self-control pattern Ph based on the self-perspective of the host vehicle 2 and an other-control pattern Po based on the other perspective of the target user 3A. Note that FIG. 6 to FIG. 12 of the first embodiment represent a traffic scene where the target user 3A is in a stationary state, but the target user 3A may, of course, be in a moving state.

As shown in FIG. 6 to FIG. 8, when the prediction data Dp includes the approach distance Lo from the driving trajectory Th of the host vehicle 2 approaching the target user 3A to the target user 3A, the planning block 120 may arbitrate the driving control pattern P to adapt to the approach distance Lo. At this time, when the prediction data Dp also includes the time to collision (TTC) of the host vehicle 2 with respect to the target user 3A, the planning block 120 determines the approach distance Lo in the trajectory section ΔT where the TTC is assumed to be below the threshold time on the driving trajectory Th.

Such distance determination is performed from the driving control points before the threshold time of the TTC to the driving control points within the trajectory section ΔT. Specifically, the distance determination is preferably performed from the driving control points at or just before the threshold time of the TTC (as in the examples of FIG. 6 to FIG. 8) to the driving control points within the trajectory section ΔT. Note that the white circles in FIG. 6 to FIG. 8 schematically illustrate the driving control points on the driving trajectory Th within the trajectory section ΔT where the TTC is below the threshold time.

As a result of the distance determination, if the approach distance Lo in the trajectory section ΔT where the TTC is below the threshold time is assumed to be equal to or greater than the threshold distance indicated by the dashed line in FIG. 6, the driving control pattern P is arbitrated to the self-control pattern Ph that provides the approach distance Lo as it is. Here, even at driving control points other than those where the distance determination is performed, the driving control pattern P is arbitrated to the self-control pattern Ph.

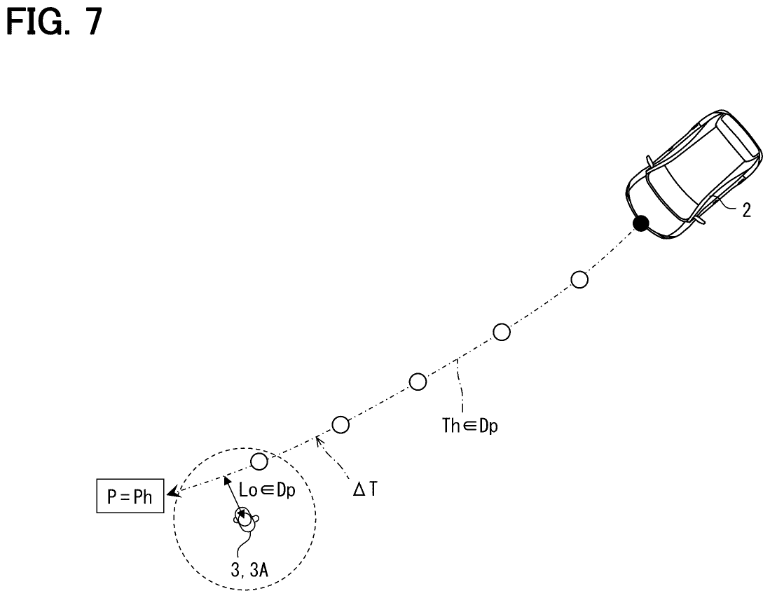

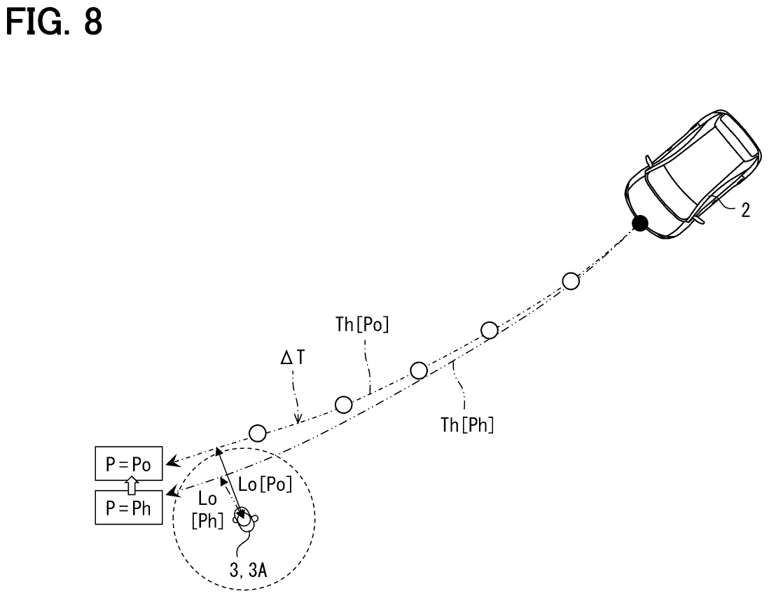

On the other hand, if the approach distance Lo in the trajectory section ΔT is assumed to be less than the threshold distance indicated by the dashed line in FIG. 7, and it is determined that a safety margin is required from the other perspective, the driving control pattern P is arbitrated to the other-control pattern Po that increases the approach distance Lo compared to the self-control pattern Ph, as shown in FIG. 8. FIG. 8 schematically illustrates the approach distance Lo on the driving trajectory Th following the self-control pattern Ph before arbitration and the expected approach distance Lo on the driving trajectory Th following the other-control pattern Po after arbitration.

The approach distance Lo shown in FIG. 6 to FIG. 8 is defined as the minimum distance (i.e., the closest distance) in the horizontal direction from the driving trajectory Th in the trajectory section ΔT to the center point of the target user 3A. The threshold time for determining the trajectory section ΔT in the arbitration to adapt to the approach distance Lo is preferably set to, for example, 2 seconds, as the time prioritizing the other perspective concerning the TTC assumed for the closest position on the driving trajectory Th to the presence position of the target user 3A.

The threshold distance for determining the necessity of prioritizing the other-control pattern Po over the self-control pattern Ph may be set to a fixed value, such as 1 meter or 1.5 meters. The threshold distance for the approach distance Lo may be variably set according to the vulnerability of the target user 3A, who is the different road user 3. In this case, for example, a pedestrian operating a baby stroller, the higher the vulnerability (i.e., the greater the vulnerability), the longer the distance value is set. The other-control pattern Po, which is prioritized over the self-control pattern Ph, may include driving control parameters for variably adjusting the approach distance Lo. Examples of driving control parameters for variably adjusting the approach distance Lo include at least one type set for the host vehicle 2, such as yaw angle parameters and yaw rate parameters.

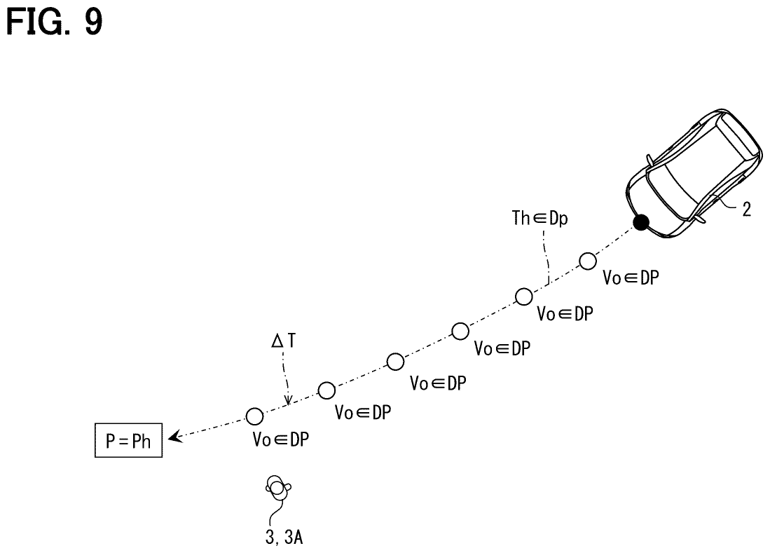

As shown in FIG. 9 to FIG. 11, when the prediction data Dp includes the time transition of the relative approach speed Vo of the host vehicle 2 approaching the target user 3A, the planning block 120 may arbitrate the driving control pattern P to adapt to the relative approach speed Vo. At this time, when the prediction data Dp also includes the TTC of the host vehicle 2 with respect to the target user 3A, the planning block 120 determines the relative approach speed Vo in the trajectory section ΔT where the TTC is assumed to be below the threshold time on the driving trajectory Th.

Such speed determination is performed from the driving control points before the threshold time of the TTC to the driving control points within the trajectory section ΔT. Specifically, the speed determination is preferably performed from the driving control points at or just before the threshold time of the TTC (as in the examples of FIG. 9 to FIG. 11) to the driving control points within the trajectory section ΔT. Note that the white circles in FIG. 9 to FIG. 11 and FIG. 12 described later schematically illustrate the driving control points on the driving trajectory Th within the trajectory section ΔT where the TTC is below the threshold time.

As a result of the speed determination, if the relative approach speed Vo in the trajectory section ΔT where the TTC is below the threshold time is assumed to be equal to or less than the threshold speed, as shown in FIG. 9, the driving control pattern P is arbitrated to the self-control pattern Ph that provides the relative approach speed Vo as it is. Here, even at driving control points other than those where the speed determination is performed, the driving control pattern P is arbitrated to the self-control pattern Ph.

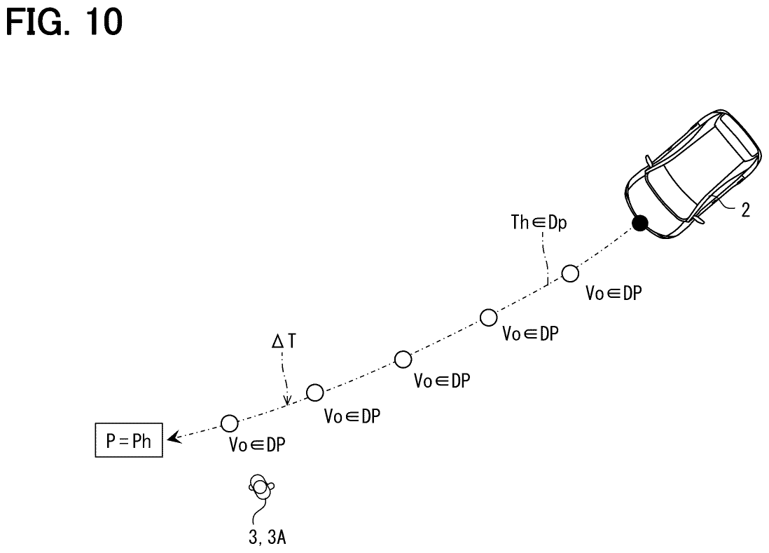

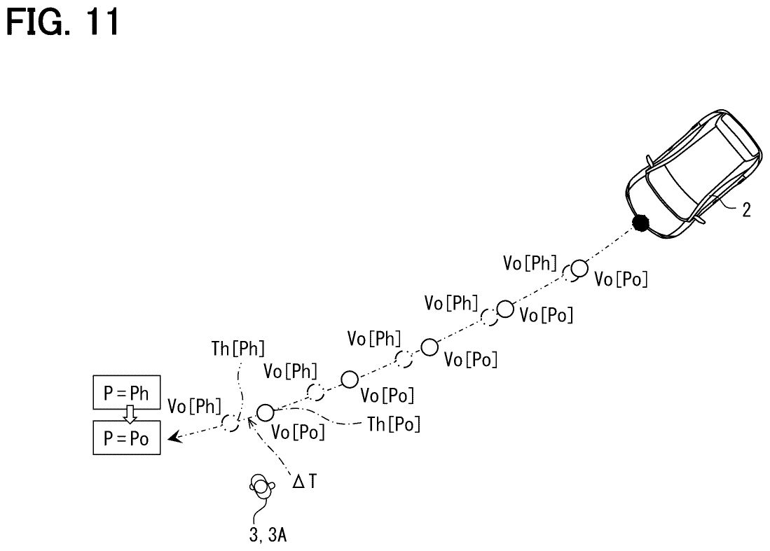

On the other hand, In the case shown in FIG. 10, where the relative approach speed Vo exceeds the threshold speed in the trajectory section ΔT and it is determined that a safe speed from the other perspective is necessary, the driving control pattern P is arbitrated to the other-control pattern Po, which lowers the relative approach speed Vo compared to the self-control pattern Ph, as shown in FIG. 11. FIG. 11 schematically illustrates the relative approach speed Vo on the driving trajectory Th following the self-control pattern Ph before arbitration and the expected relative approach speed Vo on the driving trajectory Th following the other-control pattern Po after arbitration.

The relative approach speed Vo shown in FIG. 9 to FIG. 11 is defined by assuming the closest position on the driving trajectory Th to the presence position of the target user 3A as the presence position of the target user 3A. Therefore, in FIG. 9 to FIG. 11, which illustrate the target user 3A in a stationary state as described above, the relative approach speed Vo is substantially equivalent to the driving speed of the host vehicle 2, and it is illustrated at each driving control point within the trajectory section ΔT. The threshold time for determining the trajectory section ΔT in the arbitration to adapt to the relative approach speed Vo is preferably set in accordance with the arbitration to adapt to the approach distance Lo described above.

The threshold speed for determining the necessity of prioritizing the other-control pattern Po over the self-control pattern Ph may be set to a fixed value, such as 30 km/h, based on the safety concept of Zone 30. The threshold speed for the relative approach speed Vo may be variably set according to the vulnerability of the target user 3A, who is the different road user 3. In this case, for example, a pedestrian operating a baby stroller, the higher the vulnerability (i.e., the greater the vulnerability), the lower the speed value is set. The other-control pattern Po, which is prioritized over the self-control pattern Ph, may include driving control parameters for variably adjusting the relative approach speed Vo. Examples of driving control parameters for variably adjusting the relative approach speed Vo include at least one type set for the host vehicle 2, such as speed parameters and acceleration parameters.

The arbitration to adapt to the relative approach speed Vo in the first embodiment may be combined with the arbitration to adapt to the approach distance Lo described above. In the arbitration to adapt to the relative approach speed Vo, as shown in FIG. 12, the time transition of the relative approach speed Vo may be predicted and included in the prediction data Dp based on the time change in the pixel area of the vehicle image portion Dh in the virtual video data Dm up to the threshold time of the TTC. Note that FIG. 12 schematically illustrates the pixel area of the vehicle image portion Dh, which changes over time in the virtual video data Dm, by substituting it with the area of rectangular shapes attached to each driving control point.

In the arbitration to adapt to the relative approach speed Vo, the time change in the pixel area of the vehicle image portion Dh in the virtual video data Dm up to the threshold time of the TTC, as shown in FIG. 12, may be included in the prediction data Dp instead of the time transition of the relative approach speed Vo. In this case, an event where the rate of change in the pixel area of the vehicle image portion Dh exceeds a threshold rate at or near the threshold time of the TTC may be deemed equivalent to an event where the relative approach speed Vo exceeds the threshold speed in the trajectory section ΔT, and the other-control pattern Po may be prioritized in arbitration.

The control block 140, as shown in FIG. 3, acquires the control commands, including the arbitrated driving control pattern P, from the planning block 120. The control block 140 controls the driving behavior of the host vehicle 2 according to the control commands from the planning block 120. At this time, the control block 140 may acquire recognition data from the recognition block 100 and use it for controlling the driving behavior. As a result, the host vehicle 2 is controlled to perform driving behavior that matches the prediction data Dp, which predicts interactions based on the virtual video data Dm. The control data representing the results of the controlled driving behavior is fed back from the control block 140 to the recognition block 100 and the planning block 120.

### (Driving Assistance Flow)

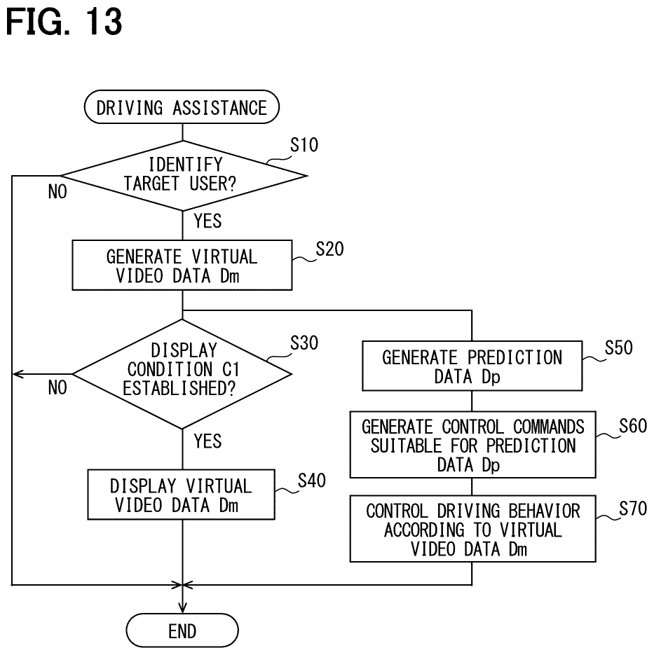

In the first embodiment, the driving assistance flow for realizing a driving assistance method to support the driving of the host vehicle 2 is repeatedly executed according to FIG. 13 through the cooperation of multiple blocks 100, 120, and 140. In the following description, each “S” in the driving assistance flow represents a step executed by multiple instructions included in the driving assistance program.

In S10, the recognition block 100 determines whether a target user 3A, which relatively approaches the host vehicle 2 in the interaction area Ia, among the different road user 3 present in the external environment of the host vehicle 2, has been identified. If a negative determination is made in S10, the current execution of the driving assistance flow ends. On the other hand, if a positive determination is made in S10, the driving assistance flow proceeds to S20.

In S20, the recognition block 100 generates virtual video data Dm that virtually represents the host vehicle 2 as viewed from the perspective of the target user 3A identified in S10. After the completion of S20, the driving assistance flow proceeds with the display sequence of S30 and S40 and the control sequence of S50, S60, and S70 in parallel.

In S30 of the display sequence, the recognition block 100 determines whether the display condition C for displaying the virtual video data Dm generated in S20 has been met. At this time, the fulfillment of the display condition C means the fulfillment of at least one of the aforementioned conditions C1, C2, C3, C4, and C5. If a negative determination is made in S30, the current execution of the driving assistance flow ends. On the other hand, if a positive determination is made in S30, the driving assistance flow proceeds to S40.

In S40 of the display sequence, the recognition block 100 displays the virtual video data Dm, for which the display condition C has been met, to the driver within the host vehicle 2 via the information presentation system 8. Upon completion of S40, the current execution of the display sequence in the driving assistance flow ends.

In S50 of the control sequence, which runs in parallel with the display sequence, the planning block 120 generates prediction data Dp predicting the interaction between the host vehicle 2 and the target user 3A based on the virtual video data Dm generated in S20. In S60 of the control sequence, the planning block 120 plans control commands to control the driving behavior of the host vehicle 2 in accordance with the prediction data Dp generated based on the virtual video data Dm in S50. Furthermore, in S70 of the control sequence, the control block 140 controls the driving behavior of the host vehicle 2 according to the control commands planned in S60, i.e., driving behavior based on the virtual video data Dm.

Upon completion of S70, the current execution of the control sequence in the driving assistance flow ends. Therefore, if the other-control pattern Po is prioritized in arbitration as a result of the current execution of the control sequence, and the condition for prioritizing the arbitration is not met in the subsequent execution of the control sequence, the driving control pattern P will be re-arbitrated to the self-control pattern Ph. Such conditions for prioritizing the other-control pattern Po may become unmet due to the autonomous driving tasks following the other-control pattern Po or due to the driver's manual driving operations under the manual driving assistance tasks following the other-control pattern Po.

### Effects and Advantages

Example of the effects and advantages of the first embodiment described so far will be explained below.

In the first embodiment, the different road user 3 (specifically, the target user 3A) present in the external environment of the host vehicle 2 is identified. Therefore, according to the first embodiment, virtual video data Dm that virtually represents the host vehicle 2 as viewed from the perspective of the different road user 3 is generated to be reflected in the driving behavior of the host vehicle 2. According to the generated virtual video data Dm, the perspective of the different road user 3 can be continuously reflected in the driving behavior of the host vehicle 2, ensuring safety and security in the interaction between the host vehicle 2 and the different road user 3.

According to the first embodiment, virtual video data Dm that can be reflected in the driving behavior of the host vehicle 2 by being displayed to a driver capable of manually driving the host vehicle 2 is generated. According to the display of the generated virtual video data Dm, the perspective of the different road user 3 can be reflected in the driving behavior of the host vehicle 2 during manual driving by the driver. Therefore, it is possible to enhance the effect of ensuring safety and security in the interaction between the host vehicle 2 and the different road user 3.

According to the first embodiment, the generated virtual video data Dm may be displayed to the driver on the condition of receiving a display request from the driver. This ensures that the perspective of the different road user 3 can be reliably reflected in the driving behavior of the host vehicle 2 during manual driving by the driver who has intentionally made a display request. Therefore, it is possible to ensure the timeliness of the effect of ensuring safety and security in the interaction between the host vehicle 2 and the different road user 3.

According to the first embodiment, the generated virtual video data Dm may be displayed to the driver on the condition that the driver is in a hands-off state. This allows the driver to determine the necessity of transferring control to manual driving based on the perspective of the different road user 3 provided through the virtual video data Dm while in a hands-off state and reflect it in the driving behavior of the host vehicle 2. Therefore, it is possible to ensure the timeliness of the effect of ensuring safety and security in the interaction between the host vehicle 2 and the different road user 3.

According to the first embodiment, the generated virtual video data Dm may be displayed to the driver on the condition that the driver is in an eyes-off state. This allows the driver to determine the necessity of transferring control to manual driving based on the perspective of the different road user 3 provided through the virtual video data Dm while in an eyes-off state and reflect it in the driving behavior of the host vehicle 2. Therefore, it is possible to ensure the timeliness of the effect of ensuring safety and security in the interaction between the host vehicle 2 and the different road user 3.

According to the first embodiment, the generated virtual video data Dm may be displayed to the driver on the condition that the host vehicle 2 is in an automatic parking process state. This allows the driver to determine the necessity of transferring control to manual driving based on the perspective of the different road user 3 provided through the virtual video data Dm during the automatic parking process of the host vehicle 2 and reflect it in the driving behavior of the host vehicle 2. Therefore, it is possible to ensure the timeliness of the effect of ensuring safety and security in the interaction between the host vehicle 2 and the different road user 3.

According to the first embodiment, the generated virtual video data Dm may be displayed to the driver on the condition that the host vehicle 2 is in an automatic low-speed driving state within a permitted speed range. This allows the driver to determine the necessity of transferring control to manual driving based on the perspective of the different road user 3 provided through the virtual video data Dm during the automatic low-speed driving of the host vehicle 2 and reflect it in the driving behavior of the host vehicle 2. Therefore, it is possible to ensure the timeliness of the effect of ensuring safety and security in the interaction between the host vehicle 2 and the different road user 3.

According to the first embodiment, virtual video data Dm that can be reflected in the driving behavior of the host vehicle 2 by being used for predicting interaction between the host vehicle 2 and the different road user 3 is generated. According to the generated virtual video data Dm, the perspective of the different road user 3, which influences the driving behavior of the host vehicle 2, can be reflected in the interaction prediction with the different road user 3. Therefore, it is possible to enhance the effect of ensuring safety and security in the interaction between the host vehicle 2 and the different road user 3.

According to the first embodiment, virtual video data Dm that can be reflected in the driving behavior of the host vehicle 2 by being used for control of the host vehicle 2 is generated. According to the control use of the generated virtual video data Dm, the perspective of the different road user 3 can be directly reflected in the driving behavior of the host vehicle 2. Therefore, it is possible to enhance the effect of ensuring safety and security in the interaction between the host vehicle 2 and the different road user 3.

According to the first embodiment, virtual video data Dm may be generated through a machine learning model that receives state information of the host vehicle 2 and the different road user 3. The generated virtual video data Dm can represent the host vehicle 2 as viewed from the perspective of the different road user 3 with a high degree of conformity to the state information of the host vehicle 2 and the different road user 3. This allows the perspective of the different road user 3 to be appropriately reflected in the driving behavior of the host vehicle 2, enhancing the reliability of ensuring safety and security in the interaction between the host vehicle 2 and the different road user 3.

In the first embodiment, still images of the host vehicle 2 may be read out from the memory 10. In this case, virtual video data Dm may be generated by periodically processing the viewpoint transformation of the vehicle image portions Dh of the still images according to the state information of the host vehicle 2 and the different road user 3. The generated virtual video data Dm can accurately represent the host vehicle 2 as viewed from the perspective of the different road user 3 by adapting to the state information of the host vehicle 2 and the different road user 3 through periodic processing of the viewpoint transformation. This allows the perspective of the different road user 3 to be continuously and appropriately reflected in the driving behavior of the host vehicle 2, enhancing the reliability of ensuring safety and security in the interaction between the host vehicle 2 and the different road user 3.

According to the first embodiment, the different road user 3 (i.e., the target user 3A in the first embodiment) that relatively approach the host vehicle 2 is identified. This allows the perspective specialized for the different road user 3 in a relative approach relationship with the host vehicle 2 to be reflected in the driving behavior of the host vehicle 2 through the generation of the virtual video data Dm. Therefore, since the interaction with the different road user 3, which have a high probability of occurring with the host vehicle 2, can be anticipated from their perspective, it is possible to enhance the reliability of ensuring safety and security.

### Second Embodiment

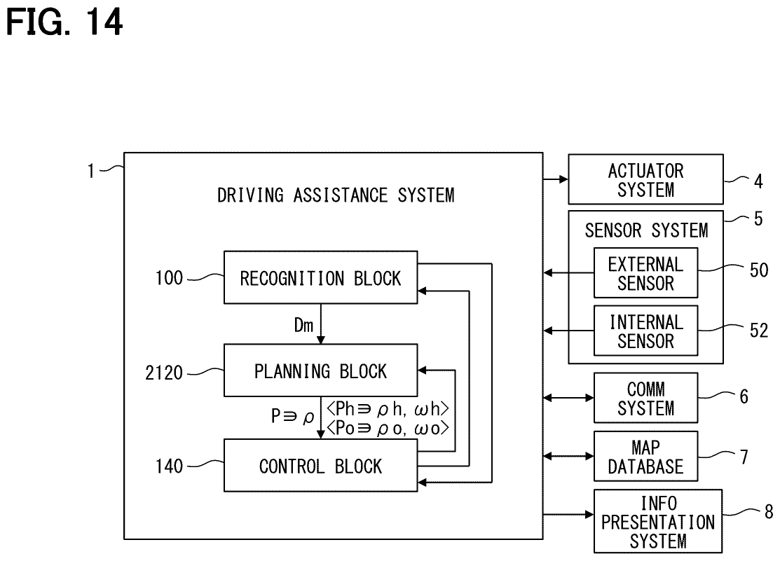

As shown in FIG. 14, the second embodiment is a modification of the first embodiment.

In the second embodiment, the control commands generated by the planning block 2120 include driving control parameters p set for the host vehicle 2 to arbitrate the driving control pattern P by weighting the self-perspective of the host vehicle 2 and the other perspective of the target user 3A. As such driving control parameters p, the planning block 2120 arbitrates between the self-control parameters ρh, which define the self-control pattern Ph, and the other-control parameters po, which define the other-control pattern Po.

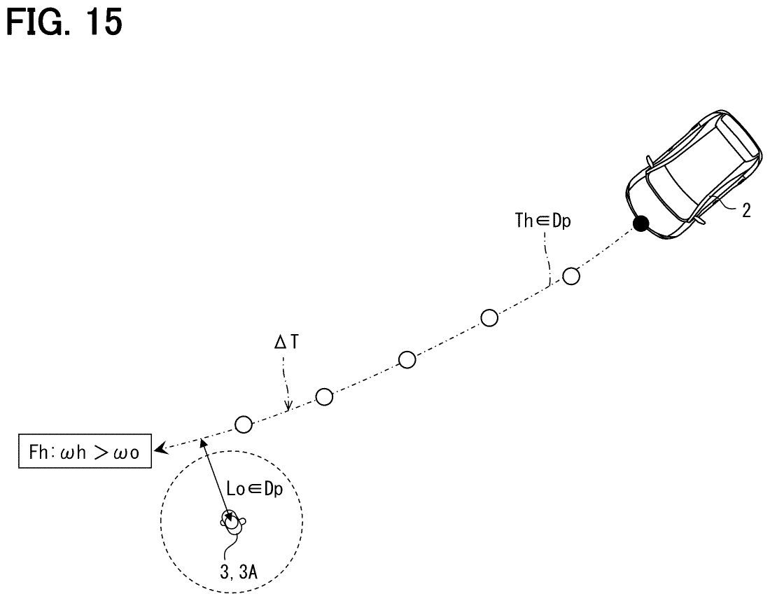

Specifically, the planning block 2120 arbitrates the weighting between the self-control parameters ρh and the other-control parameters ρo to adapt to the prediction data Dp of the interaction predicted based on the virtual video data Dm reflecting the other perspective of the target user 3A, who is the different road user 3. Therefore, the planning block 2120 sets the driving control parameters p according to the following equations 1 to 4, using the weight ωh of the self-control parameters ρh and the weight ωo of the other-control parameters ρo, as shown in FIG. 15 to FIG. 20. Such a setting is equivalent to determining the driving control pattern P by weighting arbitration between the self-control pattern Ph defined by the self-control parameters ρh and the other-control pattern Po defined by the other-control parameters ρo. Note that FIG. 15 to FIG. 20 of the second embodiment also represent a traffic scene where the target user 3A is in a stationary state, but the target user 3A may, of course, be in a moving state.

$$ρ = ω h \cdot ρ h + ω o \cdot ρ o \qquad ( Equation 1 )$$

$$ω h + ω o = 1 \qquad ( Equation 2 )$$

$$ω h \geq 0 \qquad ( Equation 3 )$$

$$ω 0 \geq 0 \qquad ( Equation 4 )$$

As shown in FIG. 15 to FIG. 17, when the prediction data Dp includes the approach distance Lo from the driving trajectory Th of the host vehicle 2 approaching the target user 3A to the target user 3A, the planning block 2120 may arbitrate the weights ωh and ωo of the driving control parameters ρ to adapt to the approach distance Lo. At this time, when the prediction data Dp also includes the TTC of the host vehicle 2 with respect to the target user 3A, the planning block 2120 determines the approach distance Lo in the trajectory section ΔT where the TTC is assumed to be below the threshold time on the driving trajectory Th.

As a result of such distance determination, if the approach distance Lo in the trajectory section ΔT where the TTC is below the threshold time is assumed to be equal to or greater than the threshold distance indicated by the dashed line in FIG. 15, the weight ωo of the other-control parameters ρo is arbitrated to be lower than the weight ωh of the self-control parameters ρh. Here, even at driving control points other than those where the distance determination is performed, the weight ωo of the other-control parameters ρo is arbitrated to be lower than the weight ωh of the self-control parameters ρh.

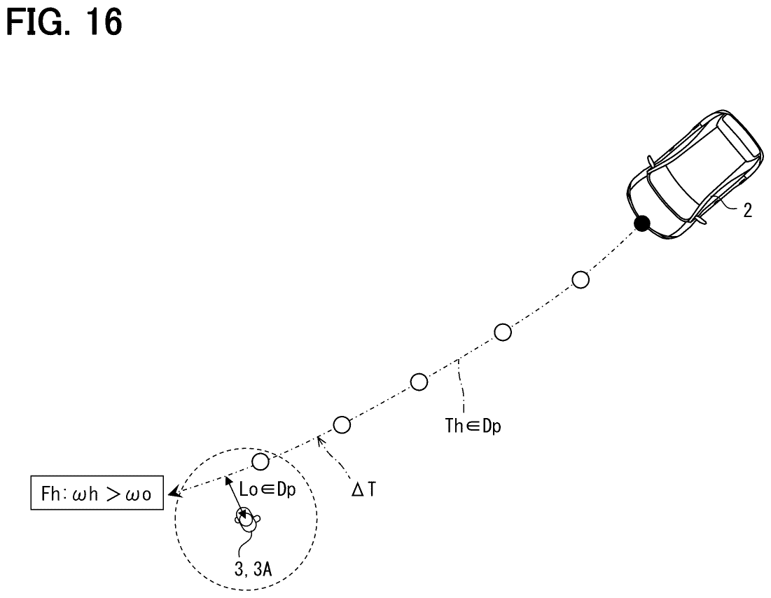

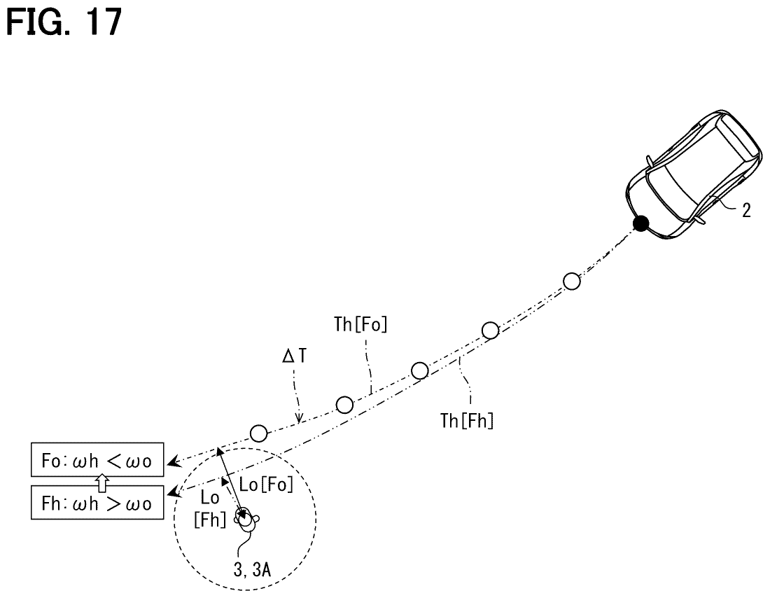

On the other hand, if the approach distance Lo in the trajectory section ΔT is assumed to be less than the threshold distance indicated by the dashed line in FIG. 16, and it is determined that a safety margin is required from the other perspective, the weight ωo of the other-control parameters ρo is arbitrated to be higher than the weight ωh of the self-control parameters ρh, as shown in FIG. 17. FIG. 17 schematically illustrates the approach distance Lo on the driving trajectory Th following the weighting relationship Fh: ωh>ωo before arbitration and the expected approach distance Lo on the driving trajectory Th following the weighting relationship Fo: ωh<ωo after arbitration.

In the arbitration to adapt to the approach distance Lo in the second embodiment, the driving control points for performing the distance determination, the approach distance Lo, the threshold time of the TTC, the threshold distance of the approach distance Lo, and the driving control parameters ρ for variably adjusting the approach distance Lo are similar to those in the arbitration to adapt to the approach distance Lo in the first embodiment. In the arbitration to adapt to the approach distance Lo in the second embodiment, the self-control parameters ρh define the self-control pattern Ph that provides the approach distance Lo as it is, and the other-control parameters ρo define the other-control pattern Po that increases the approach distance Lo compared to the self-control pattern Ph.

Therefore, the arbitration in the case of FIG. 15 in the second embodiment, where the weight ωo of the other-control parameters ρo is set to zero, is equivalent to the arbitration in the case of FIG. 6 in the first embodiment. On the other hand, the arbitration in the cases of FIG. 16 and FIG. 17 in the second embodiment, where the weight ωh of the self-control parameters ρh is set to zero, is equivalent to the arbitration in the cases of FIG. 7 and FIG. 8 in the first embodiment.

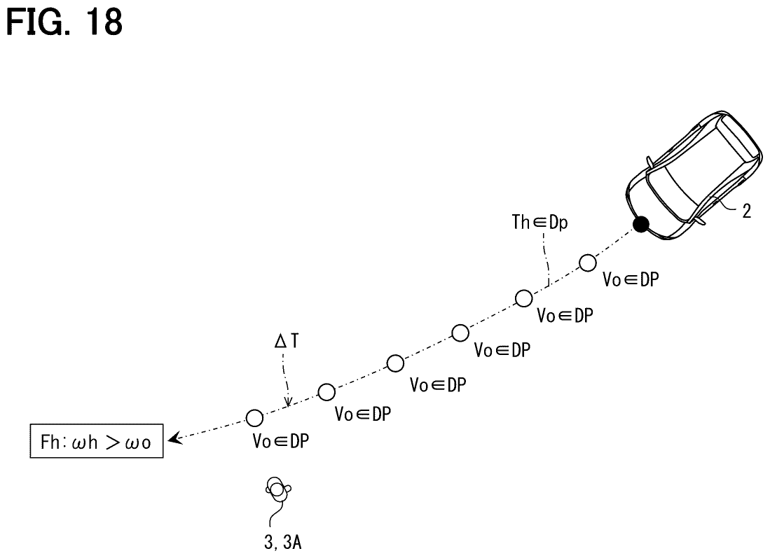

As shown in FIG. 18 to FIG. 20, when the prediction data Dp includes the time transition of the relative approach speed Vo of the host vehicle 2 approaching the target user 3A, the planning block 2120 may arbitrate the weights ωh and ωo of the driving control parameters ρ to adapt to the relative approach speed Vo. At this time, when the prediction data Dp also includes the TTC of the host vehicle 2 with respect to the target user 3A, the planning block 2120 determines the relative approach speed Vo in the trajectory section ΔT where the TTC is assumed to be below the threshold time on the driving trajectory Th.

As a result of such speed determination, if the relative approach speed Vo in the trajectory section ΔT where the TTC is below the threshold time is assumed to be equal to or less than the threshold speed, as shown in FIG. 18, the weight ωo of the other-control parameters ρo is arbitrated to be lower than the weight ωh of the self-control parameters ρh. Here, even at driving control points other than those where the speed determination is performed, the weight ωo of the other-control parameters ρo is arbitrated to be lower than the weight ωh of the self-control parameters ρh.

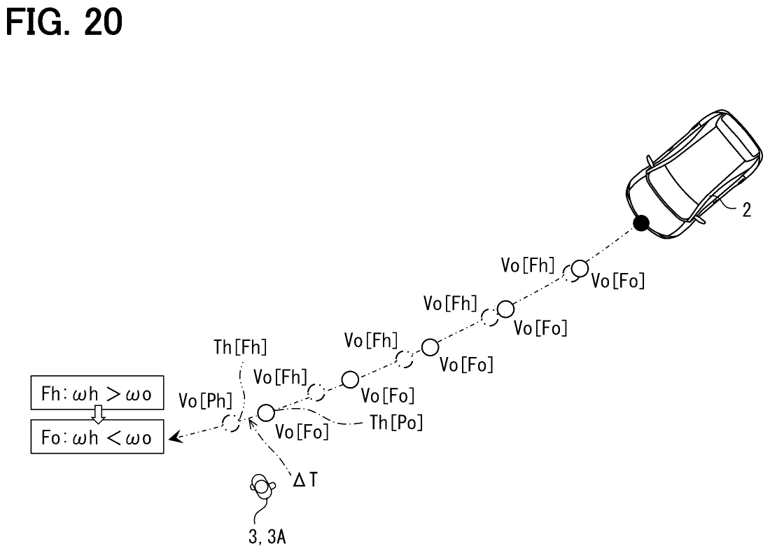

On the other hand, if the relative approach speed Vo in the trajectory section ΔT exceeds the threshold speed and it is determined that a safety speed is required from the other perspective, the weight ωo of the other-control parameters ρo is arbitrated to be higher than the weight ωh of the self-control parameters ρh, as shown in FIG. 20. FIG. 20 schematically illustrates the relative approach speed Vo on the driving trajectory Th following the weighting relationship Fh: ωh>ωo before arbitration and the expected relative approach speed Vo on the driving trajectory Th following the weighting relationship Fo: ωh<ωo after arbitration.

In the arbitration to adapt to the relative approach speed Vo in the second embodiment, the driving control points for performing the speed determination, the threshold time of the TTC, the threshold speed of the relative approach speed Vo, the driving control parameters ρ for variably adjusting the relative approach speed Vo, and the use of the vehicle image portion Dh are similar to those in the arbitration to adapt to the relative approach speed Vo in the first embodiment. In the arbitration to adapt to the relative approach speed Vo in the second embodiment, the self-control parameters ρh define the self-control pattern Ph that provides the relative approach speed Vo as it is, and the other-control parameters ρo define the other-control pattern Po that reduces the relative approach speed Vo compared to the self-control pattern Ph.

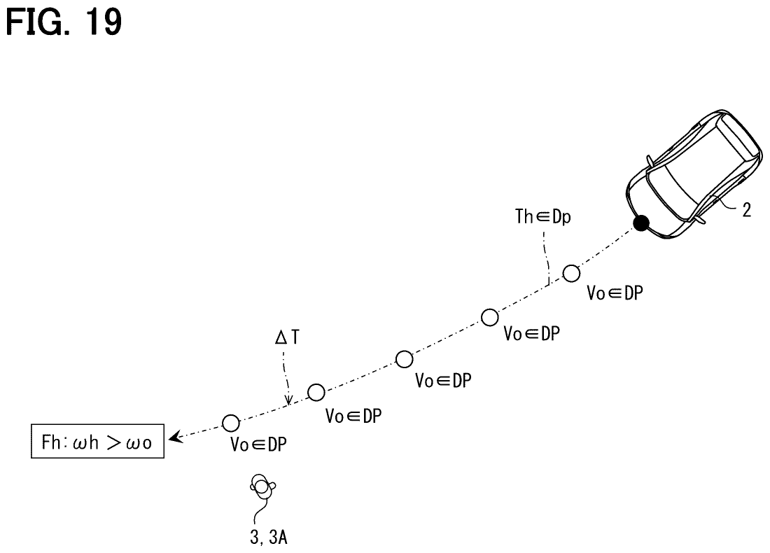

Therefore, the arbitration in the case of FIG. 18 in the second embodiment, where the weight ωo of the other-control parameters ρo is set to zero, is equivalent to the arbitration in the case of FIG. 9 in the first embodiment. On the other hand, the arbitration in the cases of FIG. 19 and FIG. 20 in the second embodiment, where the weight ωh of the self-control parameters ρh is set to zero, is equivalent to the arbitration in the cases of FIG. 10 and FIG. 11 in the first embodiment. The arbitration to adapt to the relative approach speed Vo in the second embodiment may be combined with the arbitration to adapt to the approach distance Lo in the second embodiment described above.

In the second embodiment described so far, a driving assistance flow similar to that in the first embodiment is executed. Therefore, the second embodiment also ensures safety and security in the interaction between the host vehicle 2 and the different road user 3.

### Other Embodiments

While several embodiments have been described above, the present disclosure is not limited to these embodiments and can be applied to various embodiments and combinations within the scope of the gist of the present disclosure.

In a modification, the dedicated computer constituting the driving assistance system 1 may have at least one of a digital circuit and an analog circuit as a processor. Here, the digital circuit may be at least one type selected from, for example, an ASIC (Application Specific Integrated Circuit), an FPGA (Field Programmable Gate Array), an SoC (System on a Chip), a PGA (Programmable Gate Array), and a CPLD (Complex Programmable Logic Device). Such digital circuits may also have a memory that stores programs.

In a modification, the target user 3A, which is the display target of the virtual video data Dm, may include not only the different road user 3 at the closest distance but also some or all of the different road user 3 that are farther from the host vehicle 2 within the interaction area Ia. In a modification, the control sequence executed by the planning block 120 to predict interactions and generate control commands may be omitted.

In a modification, the recognition block 100 may perform a preliminary prediction of the interaction between the host vehicle 2 and the different road user 3 based on recognition data other than the virtual video data Dm before the prediction based on the virtual video data Dm by the planning block 120. In this case, the target user 3A may be identified according to at least one type of the preliminary predicted interaction, such as probability and collision risk.

In a modification, the recognition block 100 may provide the planning block 120 with prediction data Dp predicted based on recognition data other than the virtual video data Dm instead of predicting the interaction between the host vehicle 2 and the different road user 3 based on the virtual video data Dm by the planning block 120. In this case, the target user 3A may be identified according to at least one type of the predicted interaction, such as probability and collision risk.

In a modification, the operator who manually drives the host vehicle 2 to which the driving assistance system 1 is applied may be a remote operator who remotely operates the driving of the host vehicle 2 from an external center. In this case, the virtual video data Dm may be displayed to the remote operator.

In a modification, the arbitration between the self-control pattern Ph and the other-control pattern Po may be performed according to prediction data Dp representing the risk level from the other perspective in the interaction area Ia, in addition to the approach distance Lo and the relative approach speed Vo. Specifically, the risk level may be represented by the type of road. In this case, for example, the self-control pattern Ph may be prioritized for main roads, while the other-control pattern Po may be prioritized for residential roads. Alternatively, the self-control pattern Ph may be prioritized for road structures with sidewalks, while the other-control pattern Po may be prioritized for road structures without sidewalks.

In a modification, the weighting between the self-control parameters ρh and the other-control parameters ρo may be arbitrated according to prediction data Dp representing the risk level from the other perspective in the interaction area Ia. Specifically, the risk level may be represented by the type of road. In this case, for example, the weight ωo of the other perspective may be arbitrated to be lower than the weight ωh for main roads, while the weight ωo of the other perspective may be arbitrated to be higher than the weight ωh for residential roads. Alternatively, the weight ωo of the other perspective may be arbitrated to be lower than the weight ωh for road structures with sidewalks, while the weight ωo of the other perspective may be arbitrated to be higher than the weight ωh for road structures without sidewalks.

### Additional Remarks

This specification discloses multiple technical concepts listed below, as well as various combinations of these concepts.

### (Technical Idea 1)

A driving assistance system having a processor and assisting the driving of a host vehicle, wherein the processor is configured to execute: identifying a different road user present in the external environment of the host vehicle; and generating virtual video data that virtually represents the host vehicle as viewed from the perspective of the different road user so as to be reflected in the driving behavior of the host vehicle.

### (Technical Idea 2)

The driving assistance system according to Technical Idea 1, wherein the generation of the virtual video data includes generating the virtual video data that can be reflected in the driving behavior by being displayed to a driver capable of manually driving the host vehicle.

### (Technical Idea 3)

The driving assistance system according to Technical Idea 2, wherein the generation of the virtual video data includes generating the virtual video data to be displayed to the driver on a condition of receiving a display request from the driver.

### (Technical Idea 4)

The driving assistance system according to Technical Idea 2 or 3, wherein the generation of the virtual video data includes generating the virtual video data to be displayed to the driver on a condition that the driver is in a hands-off state.

### (Technical Idea 5)

The driving assistance system according to any one of Technical Ideas 2 to 4, wherein the generation of the virtual video data includes generating the virtual video data to be displayed to the driver on a condition that the driver is in an eyes-off state.

### (Technical Idea 6)

The driving assistance system according to any one of Technical Ideas 2 to 5, wherein the generation of the virtual video data includes generating the virtual video data to be displayed to the driver on a condition that the host vehicle is in an automatic parking process state.

### (Technical Idea 7)

The driving assistance system according to any one of Technical Ideas 2 to 6, wherein the generation of the virtual video data includes generating the virtual video data to be displayed to the driver on a condition that the host vehicle is in an automatic low-speed driving state within a permitted speed range.

### (Technical Idea 8)

The driving assistance system according to any one of Technical Ideas 1 to 7, wherein the generation of the virtual video data includes generating the virtual video data that can be reflected in the driving behavior by being used for predicting interaction between the host vehicle and a different road user.

### (Technical Idea 9)

The driving assistance system according to any one of Technical Ideas 1 to 8, wherein the generation of the virtual video data includes generating the virtual video data that can be reflected in the driving behavior by being used for control of the host vehicle.

### (Technical Idea 10)

The driving assistance system according to any one of Technical Ideas 1 to 9, wherein the generation of the virtual video data includes generating the virtual video data through a machine learning model that receives state information of the host vehicle and the different road user.

### (Technical Idea 11)

The driving assistance system according to any one of Technical Ideas 1 to 10, wherein the generation of the virtual video data includes reading a still image of the host vehicle from a storage medium and periodically processing perspective transformation of the still image according to state information of the host vehicle and the different road user to generate the virtual video data.

### (Technical Idea 12)

The driving assistance system according to any one of Technical Ideas 1 to 11, wherein the identification of the different road user includes identifying the different road user that is relatively approaching the host vehicle.

The above Technical Ideas 1 to 12 may also be understood as respective technical ideas of a program and a method.

What is claimed is:

1. A driving assistance system assisting a driving of a host vehicle, the driving assistance system comprising
a processor configured to execute:
identifying a different road user present in an external environment of the host vehicle; and
generating virtual video data that virtually represents the host vehicle as viewed from a perspective of the different road user so as to be reflected in a driving behavior of the host vehicle.

2. The driving assistance system according to claim 1, wherein
generation of the virtual video data includes generating the virtual video data that can be reflect in the driving behavior by being displayed to a driver capable of manually driving the host vehicle.

3. The driving assistance system according to claim 2, wherein
the generation of the virtual video data includes generating the virtual video data to be displayed to the driver on a condition of receiving a display request from the driver.

4. The driving assistance system according to claim 2, wherein
the generation of the virtual video data includes generating the virtual video data to be displayed to the driver on a condition that the driver is in a hands-off state.

5. The driving assistance system according to claim 2, wherein
the generation of the virtual video data includes generating the virtual video data to be displayed to the driver on a condition that the driver is in an eyes-off state.

6. The driving assistance system according to claim 2, wherein
the generation of the virtual video data includes generating the virtual video data to be displayed to the driver on a condition that the host vehicle is in an automatic parking process state.

7. The driving assistance system according to claim 2, wherein
the generation of the virtual video data includes generating the virtual video data to be displayed to the driver on a condition that the host vehicle is in an automatic low-speed driving state within a permitted speed range.

8. The driving assistance system according to claim 1, wherein
generation of the virtual video data includes generating the virtual video data that can be reflected in the driving behavior by being used for predicting interaction between the host vehicle and the different road user.

9. The driving assistance system according to claim 1, wherein
generation of the virtual video data includes generating the virtual video data that can be reflected in the driving behavior by being used for control of the host vehicle.

10. The driving assistance system according to claim 1, wherein
generation of the virtual video data includes generating the virtual video data through a machine learning model that receives state information of the host vehicle and the different road user.

11. The driving assistance system according to claim 1, wherein
generation of the virtual video data includes
reading a still image of the host vehicle from a storage medium and
periodically processing perspective transformation of the still image according to state information of the host vehicle and the different road user to generate the virtual video data.

12. The driving assistance system according to claim 1, wherein
identification of the different road user includes identifying a different road user that is relatively approaching the host vehicle.

13. A non-transitory computer readable storage medium storing a driving assistance program stored in a storage medium for assisting driving of a host vehicle, the driving assistance program comprising instructions to be executed by a processor, the instructions including:
identifying a different road user present in external environment of the host vehicle; and
generating virtual video data that virtually represents the host vehicle as viewed from a perspective of the different road user so as to be reflected in driving behavior of the host vehicle.

14. A driving assistance method executed by a processor for assisting driving of a host vehicle, the method comprising:
identifying a different road user present in external environment of the host vehicle; and
generating virtual video data that virtually represents the host vehicle as viewed from a perspective of the different road user so as to be reflected in driving behavior of the host vehicle.
